(19) United States
(12) Patent Application Publication
(10) Pub. No.: US 2026/0057400 A1
(43) Pub. Date: Feb. 26, 2026

(54) SYSTEM FOR DETERMINING ACTIONABLE BRAND EQUITY

(71) Applicants: Ashish MUNGI, Bangalore (IN); Ajit RAO, Bangalore (IN); Seshagiri GUDIPUDI, Bangalore (IN)

(72) Inventors: Ashish MUNGI, Bangalore (IN); Ajit RAO, Bangalore (IN); Seshagiri GUDIPUDI, Bangalore (IN)

(21) Appl. No.: 18/811,836

(22) Filed: Aug. 22, 2024

(51) Int. Cl. G06Q 30/0203

(52) U.S. Cl. CPC G06Q 30/0203

(57) ABSTRACT

The present invention relates to a system (100) for determining actionable brand equity, comprise of a data acquisition module (127) and a data processing module (128) integrated with a brand presence assessment module (1281), a brand experience assessment module (1282), a brand edge assessment module (1283), and a brand preference assessment module (1284). The brand presence assessment module (1281) captures top-of-mind awareness responses, the brand experience assessment module (1282) utilizes net promoter scores to rank brands based on respondent experiences, the brand edge assessment module assesses brand differentiators, while the brand preference assessment module (1283), gauges brand likability. Each of the modules generate a module-level score and grade to be used by a concerned authority to produce a set of actions for improving brand presence, brand experience, brand edge and brand presence. A composite grading module combines presence, experience, edge, and preference scores to offer an actionable brand equity grade.

### FIELD OF THE INVENTION

Embodiments of the invention relate generally to data analysis system and method. More specifically, embodiments of the invention provide a system for determining actionable brand equity.

### DESCRIPTION OF THE RELATED ART

Brand equity refers to the intangible value and strength of a brand that enables it to stand out and command a premium in the market compared to generic alternatives. It represents the accumulated goodwill, perception, and reputation that a brand has developed over time in the minds of its customers and stakeholders.

Many market research agencies use statistical tools such as factor analysis to arrive at a composite brand equity index, a single number. The factor analysis is usually conducted on attributes that relate to the claimed future behaviour of customers/consumers. The problem with such an approach is that the statistical tools often have low validity. Secondly, these are not easy to explain to non-statistical people. Thirdly, marketers often complain that these methods do not lead to actionable information. There are other problems such as “inside out” view of customers, administration of large surveys, and the assumptions that one makes while using parametric statistical tools. Finally, claimed future behaviour is highly unpredictable.

Brand equity is a multifaceted concept that cannot be adequately summarized by a single metric or index. While it represents the intangible value and strength of a brand, it involves several dimensions and perspectives that contribute to how a brand is perceived in the minds of consumers and other stakeholders.

Attempting to reduce brand equity to a single number oversimplifies the complexities involved and may not provide meaningful insights for marketers. Just as an organization's financial health cannot be fully understood by a single metric, brand equity requires a comprehensive approach that considers various factors.

To truly grasp the strength of a brand, marketers must delve into consumer perception, exploring the associations, attitudes, and emotions consumers have towards the brand. Additionally, assessing brand loyalty and advocacy is crucial, as it indicates the level of customer commitment and willingness to advocate for the brand.

Brand pillars or brand equity pillars (or brand parameters) are the values and characteristics that make up a brand and define the fundamental points that set a specific brand or company apart from its competitors. Brand pillars are touchpoints that help a brand define and codify its distinct value. Each brand pillar is a step toward clearer communication. Each brand pillar breaks down the many nuances of a brand. This helps the public and consumers connect the brand to the products and services a business or company offers. It also helps customers, stakeholders, and investors understand what it means to support a particular brand and/or company. Brand equity models typically define 4 or 5 core brand pillars (or brand parameters).

Four brand pillars (or brand parameters) that are generally used in determining brand equity are, brand presence, brand experience, brand edge, brand preference.

Brand presence also known as brand awareness or brand recognition, refers to the level by which your customers remember and recognize your brand or business. The higher the brand awareness, a wider range of consumers who are familiar with the brand.

Brands with high brand awareness are generally referred to as “trending”, “buzzworthy”, or “popular”. Establishing brand awareness is valuable when marketing and promoting the company and its products, especially in the early stages of a business.

In today's highly competitive business industry, establishing a strong brand presence is important. When brand presence or brand recognition is strong, it also necessarily follows that more consumers recognize your business and therefore, the brand or business may win a significant market share. In effect, the profitability and stability as a business strengthen as well.

Brand awareness can be assessed through three distinct levels. First, there is Top-of-mind awareness (TOMA), which refers to the initial brand that comes to a customer's mind when asked spontaneously about a certain product category. This serves as a measure of brand salience, indicating how well a brand is positioned in consumers' minds. For instance, when asked about chocolates, the brand that individuals mention first contributes to their TOMA score. Only one brand can hold the TOMA position for a customer.

The second level is Unaided Awareness (UA) or Brand Recall. This involves the customer listing all brands they are aware of, apart from the one they mentioned as TOMA. In the context of chocolates, the question might be, “Which other chocolate brands do you know of?” Responses to UA can encompass multiple brands, typically around 4 to 5.

Lastly, Aided Awareness (AA) or Brand Recognition constitutes the third level of brand awareness. This stage gauges the percentage of respondents who recognize a product, brand, or advertising when prompted. In the case of chocolates, an interviewer might present a list of chocolate brands and inquire, “Which of these brands are you familiar with?” Customers can acknowledge several brands from the list.

Of these three levels, Top-of-Mind Awareness (TOMA) holds the highest significance. Brands with greater TOMA compared to competitors have a more robust presence in customers' minds. TOMA also proves to be a more robust differentiator than Unaided Awareness (UA) or Aided Awareness (AA).

Brand experience refers to the overall perception that customers have when interacting with the business. It encompasses all touchpoints across the customer journey, including advertising, digital marketing, products, and customer service. Brand experience describes the tangible and emotional experience consumers have while interacting with the brand, including elements of user experience, customer experience, and brand identity. It includes thoughts, feelings, perceptions, and reactions to everything from direct marketing efforts to large-scale ad campaigns and specific product launches.

Brand experience determines the strength of a brand and is a very important factor in determining how customers feel about a brand, especially in categories where product and/or service differences are absent. Also, the quality of experience has a big impact on word-of-mouth advertising as well as on customer churn. There are many ways of capturing brand experience, but Net Promoter Score (NPS) is the most popular.

Brand Edge, also known as brand differentiation, is the edge or differentiation that a brand or product has over other similar brands in the market. Customers don't value brands that sell the same items and don't provide them with new solutions. It makes them believe that these companies are easily interchangeable.

Brand differentiation is an essential aspect of a brand marketing strategy. It enables companies to reveal their profitable qualities that help develop a unique selling proposition. This way, they understand their competitive advantage and stand out among competitors.

Differentiation helps the brand boost its market share in the long term, resulting in an increase in the targeted audience, sales volume, and revenue. In addition, a clear and valuable unique selling proposition helps build a base of loyal clients who love the brand not only for the product but for the positive user experience and shared values.

Differentiation is based on a set of attributes—both tangible and intangible—that customers strongly associate with a brand.

Brand Preference is a marketing metric that reflects the strength of a brand in the market. This indicator shows whether consumers prefer a particular brand over other brands from the same category. Brand preference goes hand in hand with brand loyalty. When faced with the decision, customers with brand preference for a particular brand will choose that brand over other similar brands. This kind of repeat business leads to customer loyalty and brand advocates, in turn helping create a successful and sustainable business.

Brand awareness is another vital aspect, measuring the brand's visibility and recognition in the market. Differentiation plays a key role as well, as marketers need to evaluate how their brand stands out from competitors and offers a unique value proposition.

Perceived quality is yet another factor, with consumers' perceptions of the brand's product or service quality heavily influencing their brand preferences. Lastly, understanding the brand's relevance and resonance in consumers' lives is essential to gauge its overall impact and potential for growth. A singular, all-encompassing index fails to provide the necessary insights for marketers to take decisive action to enhance their brand's equity.

Therefore, due to the aforementioned drawbacks there is a need of a system and method for determining one or more actions required to enhance brand equity along different dimensions or brand pillars.

### SUMMARY

A system and method are disclosed for determining brand equity, more particularly for determining actionable brand equity based on four brand pillars or brand parameters, namely brand presence, brand experience, brand edge and brand preference.

In a preferred embodiment, the system for determining actionable brand equity is disclosed. The system comprise of one or more hardware processors, a memory coupled to the one or more hardware processors. The memory comprise a plurality of modules in the form of programmable instructions executable by the one or more hardware processors. The plurality of modules comprise of a brand presence assessment module, a brand experience assessment module, a brand edge assessment module, and a brand preference assessment module. The brand presence assessment module is configured to capture a response of a top-of-mind awareness questionnaire from a respondent, determine one or more counts and percentages of a list of brands mentioned in the top-of-mind awareness questionnaire, normalize the counts to generate a percentile score for getting a brand presence score and brand presence grade and further the grade for a particular brand is used by a concerned authority to produce a set of actions. The brand experience assessment module is configured to capture a response to the experience of the respondent with a list of currently used or recently used brands via utilizing a net promoter score technique, convert the respondent ratings into ranks for each brand to determine the top ranking brands in the list, determine one or more counts and percentages of the list of brands mentioned in the response, normalize the counts to generate a percentile score for getting a brand experience score and brand experience grade, further the grade so generated is used by a concerned authority to produce a set of actions. The brand edge assessment module is configured to capture a response of the respondent to a set of differentiation questions for a list of brands, compute a brand attribute matrix to determine one or more counts and percentages of the list of brands mentioned in the responses of the differentiation questions, normalize the counts to generate a percentile score for getting a brand edge score and a brand edge grade, further the grade so generated is used by a concerned authority to produce a set of actions. The brand preference assessment module is configured to capture a response to a brand preference question, determine one or more counts and percentages of a list of brands mentioned in the response, normalize the counts to generate a percentile score for getting a brand preference score and a brand preference grade, further the grade so generated is used by a concerned authority to produce a set of actions. Further the plurality of modules also include a composite grading module for providing an actionable brand equity grade by combining the brand presence score, brand experience score, brand edge score and a brand preference score.

In another embodiment, a method for determining actionable brand equity is disclosed. The method comprises determining if an individual brand pillar or all the brand pillars are to be assessed. The method further comprises capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions. The method further comprises capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions. The method further comprises defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions. The method further comprises capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions. The method further comprises defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions. The method further comprises capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions. The method further comprises calculating an actionable brand equity grade as a composite grade by combining the brand presence score, brand experience score, brand edge score and a brand preference score.

In another embodiment, a non-transitory computer-readable storage medium for storing one or more instructions for determining actionable brand equity. The storage medium comprises an executable code which when executed by one or more units of a system causes a processor to capture a response of a top-of-mind awareness questionnaire from a respondent. Further, the execution of the executable code by the one or more units of the system causes the processor to determine one or more counts and one or more percentages of a list of brands mentioned in the top-of-mind awareness questionnaire. Further, the execution of the executable code by the one or more units of the system causes the processor to normalize the counts to generate a percentile score for getting a brand presence score and a brand presence grade and wherein the brand presence grade for a particular brand is used by a concerned authority to produce a set of actions. Further, the execution of the executable code by the one or more units of the system causes the processor to capture a response to the experience of the respondent with a list of currently used or recently used brands via utilizing a net promoter score technique. Further, the execution of the executable code by the one or more units of the system causes the processor to convert the respondent ratings into corresponding ranks for each brand to determine the top ranking brands in the list, determine one or more counts and percentages of the list of brands mentioned in the response. Further, the execution of the executable code by the one or more units of the system causes the processor to normalize the counts to generate a percentile score for getting a brand experience score and brand experience grade, further the grade so generated is used by a concerned authority to produce a set of actions. Further, the execution of the executable code by the one or more units of the system causes the processor to capture a response of the respondent to a set of differentiation questions for a list of brands. Further, the execution of the executable code by the one or more units of the system causes the processor to compute a brand attribute matrix to determine one or more counts and corresponding percentages of the list of brands mentioned in the responses of the differentiation questions. Further, the execution of the executable code by the one or more units of the system causes the processor to calculate a differential matrix using statistical techniques, conduct significance testing on the differential matrix to compute a significance matrix and an equivalent points matrix for each brand and attribute combinations. Further, the execution of the executable code by the one or more units of the system causes the processor to normalize the counts to generate a percentile score for getting a brand edge score and a brand edge grade, further the grade so generated is used by a concerned authority to produce a set of actions. Further, the execution of the executable code by the one or more units of the system causes the processor to capture a response to a brand preference question. Further, the execution of the executable code by the one or more units of the system causes the processor to determine one or more counts and percentages of a list of brands mentioned in the response. Further, the execution of the executable code by the one or more units of the system causes the processor to normalize the counts to generate a percentile score for getting a brand preference score and a brand preference grade, further the grade so generated is used by a concerned authority to produce a set of actions. Further, the execution of the executable code by the one or more units of the system causes the processor to provide an actionable brand equity grade by combining the brand presence score, brand experience score, brand edge score and a brand preference score.

In another embodiment, a user equipment for determining actionable brand equity is disclosed. The user equipment comprises a memory, a processor connected with the memory. The processor is configured to determine an actionable brand equity via a system. Further, the actionable brand equity is determined by determining if an individual brand pillar or all the brand pillars are to be assessed. The actionable brand equity is further determined by capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions. The actionable brand equity is further determined by capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions. The actionable brand equity is further determined by defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions. The actionable brand equity is further determined by capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions. The actionable brand equity is further determined by calculating an actionable brand equity grade as a composite grade by combining the brand presence score, brand experience score, brand edge score and a brand preference score.

### BRIEF DESCRIPTION OF THE DRAWING

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of illustrating internal and external components of an embodiment of a system in which embodiments described herein may be implemented in accordance with the present disclosure.

FIG. 2 depicts a 2×2 matrix outlining the components or brand parameters for an actionable brand equity framework in accordance with the present disclosure.

FIG. 3 depicts a grading or scoring matrix that may be used for converting a numerical score or score range into a corresponding grade in accordance with the present disclosure.

FIG. 4A and FIG. 4B depicts a flow diagram of method for determining actionable brand equity in which embodiments described herein may be implemented in accordance with the present disclosure.

FIG. 5 depicts a flow diagram of a method for determining actionable brand equity in which embodiments described herein may be implemented in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a system for determining actionable brand equity. The system comprise of one or more hardware processors, a memory coupled to the one or more hardware processors. The memory comprise a plurality of modules in the form of programmable instructions executable by the one or more hardware processors. The plurality of modules comprise of a brand presence assessment module, a brand experience assessment module, a brand edge assessment module, and a brand preference assessment module. The brand presence assessment module is configured to capture a response of a top-of-mind awareness questionnaire from a respondent, determine one or more counts and percentages of a list of brands mentioned in the top-of-mind awareness questionnaire, normalize the counts to generate a percentile score for getting a brand presence score and brand presence grade and further the grade for a particular brand is used by a concerned authority to produce a set of actions. The brand experience assessment module is configured to capture a response to the experience of the respondent with a list of currently used or recently used brands via utilizing a net promoter score technique, convert the respondent ratings into ranks for each brand to determine the top ranking brands in the list, determine one or more counts and percentages of the list of brands mentioned in the response, normalize the counts to generate a percentile score for getting a brand experience score and brand experience grade, further the grade so generated is used by a concerned authority to produce a set of actions. The brand edge assessment module is configured to capture a response of the respondent to a set of differentiation questions for a list of brands, compute a brand attribute matrix to determine one or more counts and percentages of the list of brands mentioned in the responses of the differentiation questions, normalize the counts to generate a percentile score for getting a brand edge score and a brand edge grade, further the grade so generated is used by a concerned authority to produce a set of actions. The brand preference assessment module is configured to capture a response to a brand preference question, determine one or more counts and percentages of a list of brands mentioned in the response, normalize the counts to generate a percentile score for getting a brand preference score and a brand preference grade, further the grade so generated is used by a concerned authority to produce a set of actions. Further the plurality of modules also include a composite grading module for providing an actionable brand equity grade by combining the brand presence score, brand experience score, brand edge score and a brand preference score.

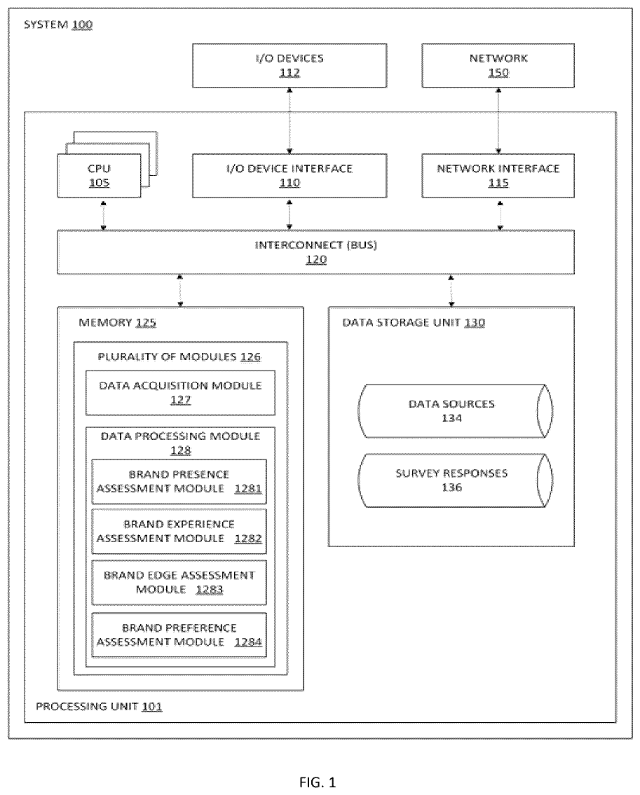

FIG. 1 depicts a block diagram of illustrating internal and external components of an embodiment of a system in which embodiments described herein may be implemented in accordance with the present disclosure. The system (100) comprises one or more processing units (101). Each processing unit (101) includes a memory (125), data storage (130), an interconnect (e.g., BUS) (120), one or more processors (e.g., CPUs) (105), an I/O device interface (110), I/O devices (112), and a network interface (115).

Each processor (105) can be communicatively coupled to the memory (125) or storage (130). Each processor (105) can retrieve and execute programming instructions stored in memory (125) or storage (130). The interconnect (120) is used to move data, such as programming instructions, between the CPU (105), I/O device interface (110), storage (130), network interface (115), and memory (125). The interconnect (bus) (120) can be implemented using one or more buses. The processors (105) can be a single CPU, multiple CPUs, or a single CPU having multiple processing cores in various embodiments. In some embodiments, a processor (105) can be a digital signal processor (DSP). Memory (125) is generally included to be representative of a random-access memory (e.g., static random-access memory (SRAM), dynamic random-access memory (DRAM), or Flash). The storage (130) is generally included to be representative of a non-volatile memory, such as a hard disk drive, solid state device (SSD), removable memory cards, optical storage, or flash memory devices. In an alternative embodiment, the storage (130) can be replaced by storage area-network (SAN) devices, the cloud, or other devices connected to the processing unit (101) via the I/O device interface (110) or a communication network (150) via the network interface (115).

The network (150) can be implemented by any number of any suitable communications media (e.g., wide area network (WAN), local area network (LAN), Internet, Intranet, etc.). In certain embodiments, the network (150) can be implemented within a cloud computing environment or using one or more cloud computing services. In some embodiments, the network interface (115) communicates with both physical and virtual networks.

The processing unit (101) and the 1/O Devices (112) can be local to each other, and communicate via any appropriate local communication medium (e.g., local area network (LAN), hardwire, wireless link, Intranet, etc.) or they can be physically separated and communicate over a virtual network. In some embodiments, the I/O devices (112) can include a display unit capable of presenting information (e.g., a survey or a set of questions) to a user and receiving one or more inputs (e.g., a survey response or a set of answers) from a user.

In some embodiments, the memory (125) stores a plurality of modules (126) including a data acquisition module (127) and a data processing module (128) while the storage (130) stores data sources (134) and survey responses (136). However, in various embodiments, the plurality of modules (126) including a data acquisition module (127) and a data processing module (128), the data sources (134), and the survey responses (136) are stored partially in memory (125) and partially in storage (130), or they are stored entirely in memory (125) or entirely in storage (130), or they are accessed over a network (150) via the network interface (115).

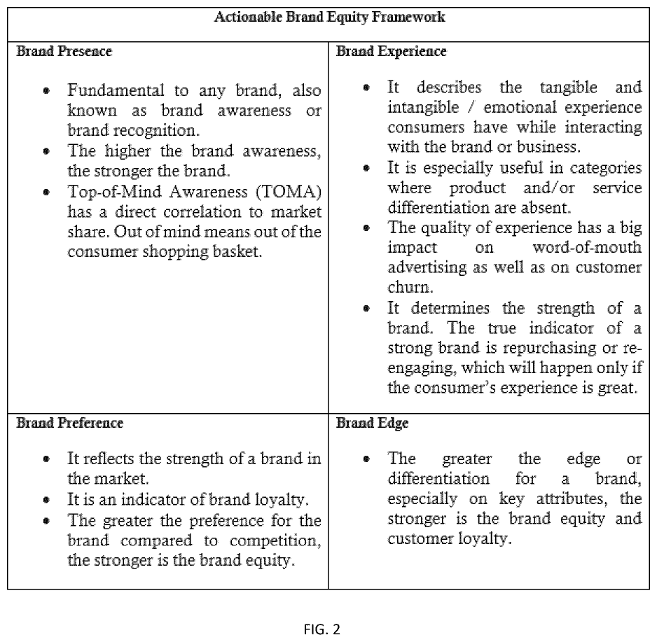

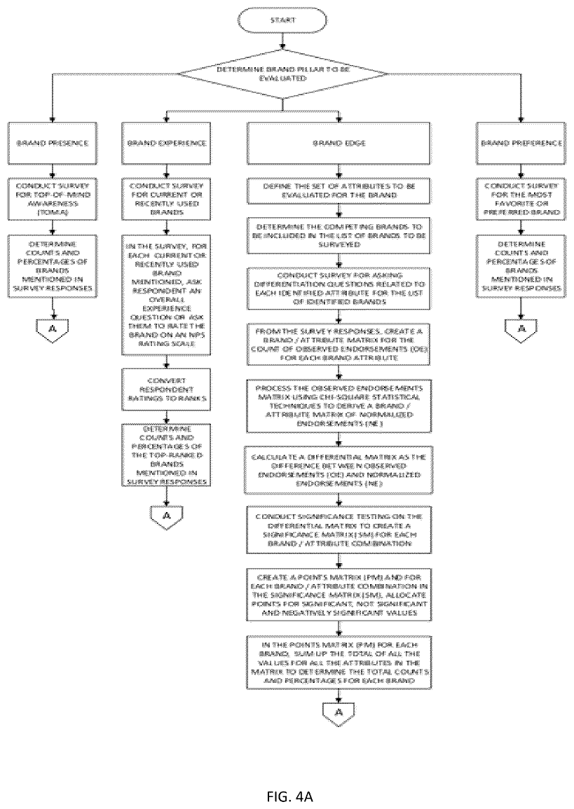

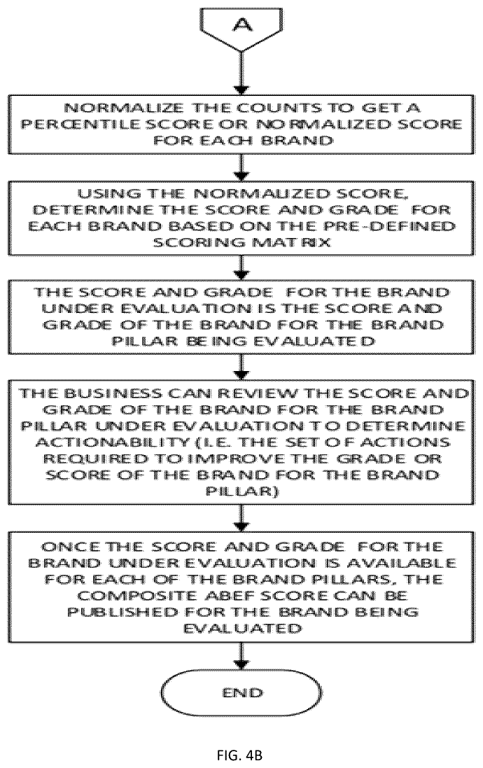

The data acquisition module (127) and data processing module (128) can store processor executable instructions for various methods such as the methods shown and described hereinafter with respect to FIG. 2 thru FIG. 4B or the equivalents thereof. In some embodiments, the data sources (134) can comprise documents containing tabular data such as, but not limited to, Portable Document Format (PDF), Word, Excel, PowerPoint, Open Document Format, Google Documents, or other document files. The data sources (134) can contain media such as video files, audio files, images and animations in various file formats such as, but not limited to, MP4, MOV, MP3, WAV, JPG, PNG, GIF, etc. The data sources (134) can further contain web content such as, but not limited to, hypertext markup language (HTML) web content, extensible markup language (XML) web content, or other web content. The survey responses (136) can comprise both actual responses received through the surveys, computed data fields and data indices in various embodiments. In some cases, the survey responses (136) are generated by one or more processors (105) evaluating one or more data sources (134) according to data processing module (128) instructions.

The memory (125) comprises a plurality of modules (126) in the form of programmable instructions executable by the one or more hardware processors (105). The plurality of modules (126) comprise a data acquisition module (127) and a data processing module (128).

The data acquisition module (127) is configured to conduct surveys related to brand presence assessment, brand experience assessment, brand edge assessment and brand preference assessment and capturing the input responses of respondents to these surveys.

The plurality of modules (126) comprise of a data processing module (128) that is integrated with a brand presence assessment module (1281), a brand experience assessment module (1282), a brand edge assessment module (1283), and a brand preference assessment module (1284). The brand presence assessment module (1281) is configured to capture a response of a top-of-mind awareness questionnaire from a respondent, determine one or more counts and percentages of a list of brands mentioned in the top-of-mind awareness questionnaire, normalize the counts to generate a percentile score for getting a brand presence score and brand presence grade and further the grade for a particular brand is used by a concerned authority to produce a set of actions. The brand experience assessment module (1282) is configured to capture a response to the experience of the respondent with a list of currently used or recently used brands via utilizing a net promoter score technique, convert the respondent ratings into ranks for each brand to determine the top ranking brands in the list, determine one or more counts and percentages of the list of brands mentioned in the response, normalize the counts to generate a percentile score for getting a brand experience score and brand experience grade, further the grade so generated is used by a concerned authority to produce a set of actions. The brand edge assessment module (1283) is configured to capture a response of the respondent to a set of differentiation questions for a list of brands, compute a brand attribute matrix to determine one or more counts and percentages of the list of brands mentioned in the responses of the differentiation questions, normalize the counts to generate a percentile score for getting a brand edge score and a brand edge grade, further the grade so generated is used by a concerned authority to produce a set of actions. The brand preference assessment module (1284) is configured to capture a response to a brand preference question, determine one or more counts and percentages of a list of brands mentioned in the response, normalize the counts to generate a percentile score for getting a brand preference score and a brand preference grade, further the grade so generated is used by a concerned authority to produce a set of actions. Further the plurality of modules also include a composite grading module for providing an actionable brand equity grade by combining the brand presence score, brand experience score, brand edge score and a brand preference score.

Referring to FIG. 4(A) and FIG. 4(B), flowcharts of overall working of the system for determining actionable brand equity is depicted.

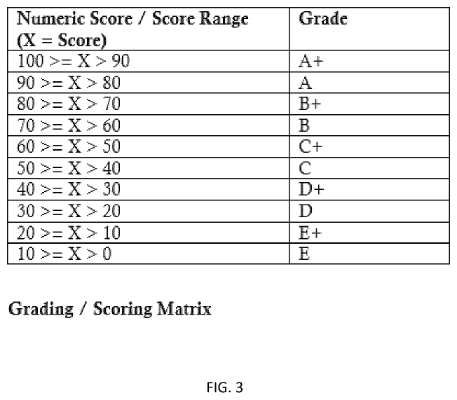

Each of the four brand parameters (brand presence, brand experience, brand edge and brand preference) of actionable brand equity framework as per our present invention and as depicted in FIG. 2 may be graded or rated based on the proposed grading or scoring matrix depicted in FIG. 3 that may be used for converting a numerical score or score range into a corresponding grade in accordance with the present disclosure.

The present invention outlines the process for grading or rating of each brand parameter as per the detailed steps below.

### Brand Presence:

The brand presence module works through a Top-of-Mind Awareness (TOMA) technique to determine the awareness about a particular brand.

### Step 1: TOMA Question:

The working starts by asking respondents an appropriate TOMA question, such as “When you think of Category X, which is the first brand that comes to mind?” Here, “Category X” is the category or classification of the brand for which the TOMA question is being asked. For example, if a brand of chocolates “Choco” is being surveyed, the TOMA question may be worded as “When you think of chocolates, which is the first brand that comes to mind?”

### Step 2: Determine Counts and Percentages of the Brands Mentioned in the TOMA Responses:

Based on the responses received, the present invention tabulates the counts and percentages of the various brands that respondents have mentioned in their responses. Table 1 depicts an illustration of responses.

TABLE 1
Illustration of responses

| | TOMA | TOMA Percentage |
|---|---|---|
| Brand | Count | (of total responses) |
| C1 | 40 | 40% |
| C2 | 30 | 30% |
| Choco | 20 | 20% |
| C4 | 6 | 6% |
| C5 | 4 | 4% |
| TOTAL | 100 | 100% |

### Step 3: Normalize the Counts to Get a Percentile Score:

Next, the present invention anchors the brand with the highest TOMA score in the category at 100 and then adjusts or normalizes the TOMA score of all the other brands to align with the normalized score of the highest TOMA brand. Effectively, the normalization process will determine the percentile scores for each brand.

From the example, the normalized count/percentile as below in Table 2.

TABLE 2
Normalized Count/Percentile

| | TOMA | Normalized Count |
|---|---|---|
| Brand | Count | (Percentile) |
| C1 | 40 | 100 |
| C2 | 30 | 75 |
| Choco | 20 | 50 |
| C4 | 6 | 15 |
| C5 | 4 | 10 |
| TOTAL | 100 | 250 |

### Step 4: Grading/Rating the Parameter

The present invention compares the normalized counts for each brand against the scoring matrix in FIG. 3 to determine the grade and score for the brand.

From example in the previous step, the brand Choco has the normalized count of 50. Hence its score is 50.

From FIG. 3, a score of 50 corresponds to a grade of C. Thus, the grade C for Choco brand in this example is determined.

### Step 5: Actionability

Based on the grade and rating determined in the previous step, the brand management and marketers now know that their brand Choco is at grade C, with a score of 50, on the brand presence parameter.

So, they may ask themselves pertinent business questions around how they may improve the Top-of-Mind Awareness (TOMA) of their brand Choco so that the TOMA score is comparable with the other brands C2 or C1 in the market (as per the illustrative ranking in Table 2).

Based on the answers to the business questions, the actions required to be taken by the business to improve the TOMA score for their brand may be determined by the business. These actions may be in the form of corrective measures, new initiatives, or any other suitable tasks applicable to the business.

Thus, the present invention provides an approach and framework for the Brand Presence score to be actionable by the business.

### Brand Experience

Further the working of brand experience assessment module works involves the following steps:

Step 1: The brand experience assessment module may measure brand experience in many different ways using existing techniques. However, for the purposes of this invention, it is assumed that the Net Promoter Score (NPS) is used to capture feedback on a respondent's experience with a brand or product.

1. First, ask the customer to identify all the brands that the customer is currently using or has used in the recent past. Usually, most customers name 3 or 4 brands that they are currently using or have recently used, but in some cases respondents may name 5 to 6 brands.

2. For each of the recently used brands named by the respondent, the system asks an NPS question, such as “On a scale of 0 to 10, how satisfied are you with your overall experience with Brand X?” to capture the experience rating for that brand. Since the NPS scale is on 0 to 10, with a rating of 9 or 10 being classified as promoters, a rating of 7 or 8 being classified as passives, and a rating of 0 through 6 being classified as detractors, the present invention uses the NPS rating provided by each respondent to rank a brand.

If an organization does not wish to use NPS in this context, the system may ask a question to determine the overall experience with the brand in any other way to gather a rank or rating from the respondent. Further, if actual churn figures are available then this churn data can be used in place of the ratings.

### Step 2: Determine Counts and Percentages of the Brands Mentioned in the Experience Question Responses:

Based on the ratings provided by respondents to the NPS (or overall experience) question, the ranks of all the recently used brands by the customer is calculated by the system, and depicted by the illustration in Table 3.

Continuing the Choco chocolate example from the previous sections, the respondent rated their brand experience with the 5 brands as follows:

TABLE 3
Respondent Rating of Brand Experience

| | NPS Rating (or Overall | |
|---|---|---|
| | Experience Rating) | Brand Rank |
| Brand | by Respondent | (by the system) |
| C1 | 9 | 1 |
| C2 | 8 | 2 |
| Choco | 7 | 3 |
| C4 | 5 | 4 |
| C5 | 2 | 5 |

If a respondent ranks two brands the same in the NPS (or overall experience rating), then the brands with the same rating are ranked the same, as illustrated below in Table 4.

TABLE 4
Respondent Rating of Brand Experience

| | NPS Rating (or Overall | |
|---|---|---|
| | Experience Rating) | Brand Rank |
| Brand | by Respondent | (by the system) |
| C1 | 9 | 1 |
| C2 | 8 | 2 |
| Choco | 8 | 2 |
| C4 | 5 | 4 |
| C5 | 2 | 5 |

Next, the cumulative top ranks for each brand (i.e. where the brand is ranked 1 by a respondent), and the top rank percentage for each brand is calculated. This is illustrated below in Table 5.

TABLE 5
Top Rank % of brands

| | Top Rank | % Top Rank |
|---|---|---|
| Brand | (Rank = 1) Count | (Rank = 1) |
| C1 | 30 | 30% |
| C2 | 25 | 25% |
| Choco | 20 | 20% |
| C4 | 15 | 15% |
| C5 | 10 | 10% |
| TOTAL | 100 | 100% |

### Step 3: Normalize the Counts to Get a Percentile Score:

Next, the present invention anchors the brand with the highest experience score in the category at 100 and then adjusts or normalizes the score of all the other brands to align with the normalized score of the highest brand. Effectively, the normalization process determines the percentile scores for each brand.

From the example, the normalized count/percentile is calculated as below in Table 6.

TABLE 6
Normalized count/percentile

| | Top Rank | Percentile |
|---|---|---|
| Brand | (Rank = 1) Count | (Rank = 1) |
| C1 | 30 | 100 |
| C2 | 25 | 83 |
| Choco | 20 | 67 |
| C4 | 15 | 50 |
| C5 | 10 | 33 |
| TOTAL | 100 | 333 |

If actual churn data is used, then the brand with the lowest churn is normalized/anchored at 100 by the present invention and all the other brands are normalized appropriately. This normalization is done by multiplying the lowest brand churn figure with 100 and dividing the resultant with a brand's actual churn figure to get normalized counts similar to the Table 6 above.

### Step 4: Grading/Rating the Parameter

The normalized counts for brands with Rank 1 are compared against the scoring matrix in FIG. 3 to determine the grade and score for the brands.

From the example in the previous step, the brand Choco has the normalized count of 67. Hence its score is 67.

From FIG. 3, a score of 67 corresponds to a grade of B. Thus, the grade B for Choco brand in this example is determined.

### Step 5: Actionability

Based on the grade and rating determined in the previous step, the brand management and marketers now know that their brand Choco is at grade B, with a score of 67, on the brand experience parameter.

So, the business can ask itself pertinent questions around how the overall experience of their brand Choco can be improved so that the score can be more comparable with the other higher ranked brands C2 or C1 in the market (as per the illustrative ranking in Table 6).

Based on the answers to the business questions, the actions required to be taken by the business to improve the overall experience score for their brand may be determined by the business. These actions may be in the form of corrective measures, new initiatives, or any other suitable tasks applicable to the business.

Thus, the present invention provides an approach and framework for the Brand Experience score to be actionable by the business.

### Brand Edge

Brands are differentiated on a set of attributes, both tangible and intangible. Product testing studies and brand track studies typically use associative scales to get consumers to evaluate a set of brands or products against a set of pre-defined attributes.

### Step 1: Differentiation Questions

Typically, the process involves defining a set of attributes that need to be evaluated or endorsed across a set of brands. The consumers are asked a question related to the brand and attribute, such as “Do you rate Brand X high on Attribute Y” or “Do you agree with the statement—Brand X displays Attribute Y” ? The response is a Yes/No or True/False answer. When the respondent agrees with an attribute statement (as a Yes or True answer), it is an endorsement.

Continuing the Choco example, the Choco and the other brands C1, C2, C4 and C5 on the attribute “chocolatiness” are evaluated. The question “Do you rate Choco high on its chocolatiness?” or “Do you agree with the statement—Choco has a lot of chocolatiness” are asked?

Step 2: Determine the counts and percentages of the brands mentioned in the differentiation question responses.

The following process and steps are performed to identify the attributes on which a brand is differentiated:

1. The endorsements of attributes for a brand are captured using an association scale and not using a rating scale.

2. All the observed values—attribute endorsements for each brand—will be organized into a brand/attribute matrix as shown below in Table 7.

TABLE 7
Observed Endorsements

| | | | | |
|---|---|---|---|---|
| Brand A | Brand B | Brand C | Brand D | Brand E |

Attribute 1
Attribute 2
Attribute 3
Attribute 4
Attribute 5
Attribute 6
Attribute 7
Attribute 8
Attribute 9
Attribute 10

### Matrix A: Observed Endorsements

Each cell in the Observed Endorsements matrix contains the counts of respondents who associated/endorsed an attribute with a brand.

3. From the above matrix of observed values, using the principles of chi-square technique (probability theory) another matrix of normalised or expected values is depicted in Table 8.

TABLE 8
Expected/Normalized Endorsements

| | | | | |
|---|---|---|---|---|
| Brand A | Brand B | Brand C | Brand D | Brand E |

Attribute 1
Attribute 2
Attribute 3
Attribute 4
Attribute 5
Attribute 6
Attribute 7
Attribute 8
Attribute 9
Attribute 10

### Matrix B: Normalized Endorsements

4. The next step is to calculate:
a. a differential matrix that is essentially the difference between the observed values and the Expected/Normalised values.
b. From this differential matrix, one can understand if the difference between observed and expected/normalised value is statistically significant or not using a standard test of significance of proportions.
c. Note: for the significance testing, the base sample size of each brand is the percentage of customers who are aware of the brand.
d. The outcome of a matrix post significance testing is displayed below in Table 9:

TABLE 9
Outcome of Significance Testing

| | Brand A | Brand B | Brand C | Brand D | Brand E |
|---|---|---|---|---|---|
| Attribute 1 | Sig | Sig | Not Sig | Neg Sig | Not Sig |
| Attribute 2 | Not Sig | Sig | Not Sig | Neg Sig | Neg Sig |
| Attribute 3 | Neg Sig | Not Sig | Sig | Sig | Neg Sig |
| Attribute 4 | Sig | Neg Sig | Neg Sig | Not Sig | Sig |
| Attribute 5 | Sig | Neg Sig | Not Sig | Not Sig | Sig |
| Attribute 6 | Sig | Not Sig | Sig | Not Sig | Neg Sig |
| Attribute 7 | Not Sig | Sig | Sig | Neg Sig | Sig |
| Attribute 8 | Not Sig | Not Sig | Neg Sig | Sig | Sig |
| Attribute 9 | Sig | Neg Sig | Not Sig | Sig | Sig |
| Attribute 10 | Neg Sig | Sig | Not Sig | Neg Sig | Sig |

5. Next, there is a requirement to allocate points for significant (“Sig” in the Table 9 above), not significant (“Not Sig” in the Table 9 above) and negative significance (“Neg Sig” in the Table 9 above). The present invention suggests allocation of 0 points for negative significance, 5 points for no significance and 10 points for significant differences. Any other relevant point allocation scale can also be used. The matrix in Table 9 is like the Table 10 below after allocation of significance points:

TABLE 10
Significance Points Matrix

| | Brand A | Brand B | Brand C | Brand D | Brand E |
|---|---|---|---|---|---|
| Attribute 1 | 10 | 10 | 5 | 0 | 5 |
| Attribute 2 | 5 | 10 | 5 | 0 | 0 |
| Attribute 3 | 0 | 5 | 10 | 10 | 0 |
| Attribute 4 | 10 | 0 | 0 | 5 | 10 |
| Attribute 5 | 10 | 0 | 5 | 5 | 10 |
| Attribute 6 | 10 | 5 | 10 | 5 | 0 |
| Attribute 7 | 5 | 10 | 10 | 0 | 110 |
| Attribute 8 | 5 | 5 | 0 | 10 | 10 |
| Attribute 9 | 10 | 0 | 5 | 10 | 10 |
| Attribute 10 | 0 | 10 | 5 | 0 | 10 |
| TOTAL | 65 | 55 | 55 | 45 | 65 |

### Step 3: Normalize the Counts to Get a Percentile Score:

From the above Table 10, an aggregate “differentiation number” for each brand is obtained. As per the present invention, the highest “differentiation number” is anchored at 100 and all the other brands are normalized accordingly. In the above case, the normalized indices are like the Table 11 below:

TABLE 11
Normalised Indices

| | Brand A | Brand B | Brand C | Brand D | Brand E |
|---|---|---|---|---|---|
| Sum | 65 | 55 | 55 | 45 | 65 |
| Normalised | 100 | 85 | 85 | 69 | 100 |

From the Choco example, Brand A, B, C, D, E are assumed to be C1, C2, Choco, C4, C5, their normalized count/percentile are given in Table 12 below:

TABLE 12
Normalized Count/Percentile

| | Significance | Normalized Count |
|---|---|---|
| Brand | Points Count | (Percentile) |
| C1 | 65 | 100 |
| C2 | 55 | 85 |
| Choco | 55 | 85 |
| C4 | 45 | 69 |
| C5 | 65 | 100 |
| TOTAL | 100 | 439 |

### Step 4: Grading/Rating the Parameter

The normalized counts for brands based on their significance counts are compared against the scoring matrix in FIG. 3 to determine the grade and score for the brands.

From the example in the previous step, the brand Choco has the normalized count of 85. Hence its score is 85.

From FIG. 3, a score of 85 corresponds to a grade of A. Thus, the grade A for Choco brand is determined in this example.

### Step 5: Actionability

Based on the grade and rating determined in the previous step, the brand management and marketers now know that their brand Choco is at grade A, with a score of 85 on the brand edge parameter.

So, the business can ask itself pertinent questions around how to improve the overall differentiation of the brand Choco, so that the brand edge score for Choco is comparable with the other brands C1 or C5 (both with score 100) in the market.

Based on the answers to the business questions, the actions required to be taken by the business to improve the overall differentiation score for their brand may be determined by the business. These actions may be in the form of corrective measures, new initiatives, or any other suitable tasks applicable to the business.

Thus, the present invention provides an approach and framework for the Brand Edge/Brand Differentiation score to be actionable by the business.

### Brand Preference

In a highly competitive context, often it is observed that there is very little difference between top ranked brands on Presence, Experience and Differentiation parameters. In such situations, Brand Preference parameter plays a key role and brings out the “X factor” of a brand.

### Step 1: Brand Preference Question

Brand preference is best measured by the question—“Which is your most favourite brand?”

### Step 2: Determine Counts and Percentages of the Brands Mentioned in the Responses:

Based on the responses received, the counts and percentages of the various brands that respondents have mentioned in their responses are tabulated and calculated by the system.

For the purposes of illustration, continuing the previous example, the following counts and percentages are depicted in Table 13.

TABLE 13
Percentage of Total Response

| | Preference | Percentage (of |
|---|---|---|
| Brand | Count | total responses) |
| C1 | 10 | 10% |
| C2 | 20 | 20% |
| Choco | 50 | 50% |
| C4 | 15 | 15% |
| C5 | 5 | 5% |
| TOTAL | 100 | 100% |

### Step 3: Normalize the Counts to Obtain a Percentile Score

The present invention anchors the brand with the highest score in the category at 100 and then adjusts or normalizes the score of all the other brands to align with the normalized score of the highest brand. Effectively, the percentile scores for each brand is determined by the normalization process.

From the example and counts in Table 13, the normalized count/percentile is depicted in Table 14.

TABLE 14
Normalized Count/Percentile

| | Preference | Normalized |
|---|---|---|
| Brand | Count | Count/Percentile |
| C1 | 10 | 20 |
| C2 | 20 | 40 |
| Choco | 50 | 100 |
| C4 | 15 | 30 |
| C5 | 5 | 10 |
| TOTAL | 100 | 200 |

### Step 4: Grading/Rating the Parameter

The normalized counts for brands based on their preference counts are compared against the scoring matrix in FIG. 3 to determine the grade and score for the brands.

From the example in the previous step Table 14, the brand Choco has the normalized count of 100. Hence, its score is 100.

From FIG. 3, a score of 100 corresponds to a grade of A+. Thus, the grade A+ for Choco brand is determined in this example.

### Step 5: Actionability

Based on the grade and rating determined in the previous step, the brand management and marketers now know that the brand Choco is at grade A+, with a score of 100, which is the highest possible rating and score, on the brand preference parameter.

So, the business can ask itself pertinent questions around how to retain and perhaps to even increase the preference of the brand Choco compared with the other brands in the market.

Based on the answers to the business questions, the actions required to be taken by the business to retain and perhaps even increase the preference score for the brand can be determined by the business. These actions may be in the form of corrective measures, new initiatives, or any other suitable tasks applicable to the business.

Thus, the present invention provides an approach and framework for the Brand Preference score to be actionable by the business.

### Actionable Brand Equity Grading/Composite Grading

Once the grades for the brand across all the 4 brand parameters are determined as per the present invention, a composite grade or an Actionable Brand Equity Grade is provided, which is a combination of the 4 grades for the 4 parameters.

Actionable Brand Equity Grade (Presence, Experience, Edge, Preference)=[GP1, GE1, GE2, GP2]

For the Choco brand example, the Actionable Brand Equity Grade is: [C, B, A, A+].

In an implementation, the system (100) may reside in a server or may operate in parallel with the server. In another implementation, the system (100) may be present in a user equipment such as a mobile phone, an electronic tablet or alike.

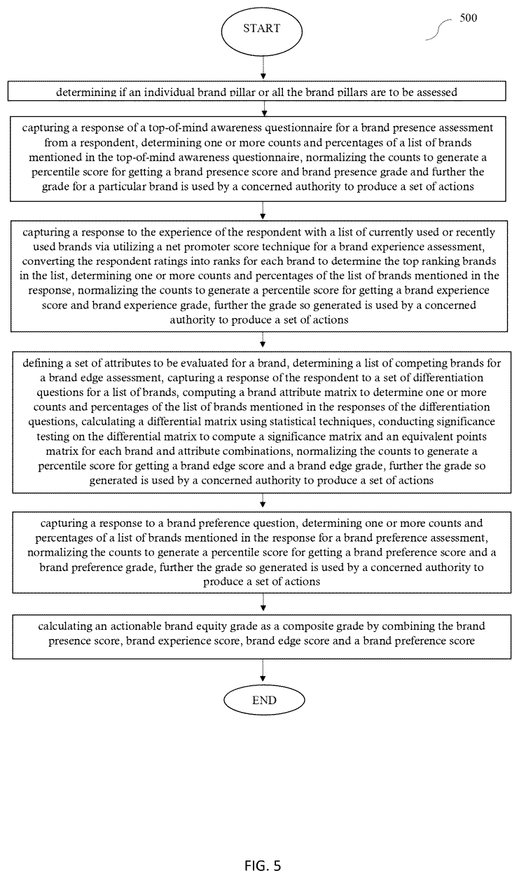

FIG. 5 depicts a flow diagram of a method for determining actionable brand equity in which embodiments described herein may be implemented in accordance with the present disclosure.

The present invention also provides a method for determining actionable brand equity. In an implementation, the method is implemented on the system. The method comprises steps of determining if an individual brand pillar or all the brand pillars are to be assessed. The actionable brand equity includes but not limited to the brand pillars of brand presence, brand experience, brand edge and brand preference.

The method further comprises capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions. In an implementation, the set of actions refer to corrective measures, new initiatives, or any other suitable tasks.

The method further comprises capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions.

The method further comprises defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions. In an implementation, the set of differentiation questions via the brand edge assessment module inquire about a plurality of attributes of brands, including quality, pricing, features, and customer service, to assess their unique selling propositions.

The method further comprises capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions.

The method further comprises defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions.

The method further comprises capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions.

The method further comprises calculating an actionable brand equity grade as a composite grade by combining the brand presence score, brand experience score, brand edge score and a brand preference score. In an implementation, the actionable brand equity grade provided by the composite grading module is represented on a scale ranging from low to high, with an optional set of corresponding recommendations for improving brand equity.

In an implementation, the actionable brand equity grade are displayed through a graphical user interface which presents the actionable brand equity grade and the related set of actions and recommendations for improving brand equity in a visual dashboard format and a downloadable report format for a clear visualization and interpretation.

The present invention further provides a non-transitory computer-readable storage medium for storing one or more instructions for determining actionable brand equity. The storage medium comprises an executable code which when executed by one or more units of a system causes a processor to capture a response of a top-of-mind awareness questionnaire from a respondent. Further, the execution of the executable code by the one or more units of the system causes the processor to determine one or more counts and one or more percentages of a list of brands mentioned in the top-of-mind awareness questionnaire. Further, the execution of the executable code by the one or more units of the system causes the processor to normalize the counts to generate a percentile score for getting a brand presence score and a brand presence grade and wherein the brand presence grade for a particular brand is used by a concerned authority to produce a set of actions. Further, the execution of the executable code by the one or more units of the system causes the processor to capture a response to the experience of the respondent with a list of currently used or recently used brands via utilizing a net promoter score technique. Further, the execution of the executable code by the one or more units of the system causes the processor to convert the respondent ratings into corresponding ranks for each brand to determine the top ranking brands in the list, determine one or more counts and percentages of the list of brands mentioned in the response. Further, the execution of the executable code by the one or more units of the system causes the processor to normalize the counts to generate a percentile score for getting a brand experience score and brand experience grade, further the grade so generated is used by a concerned authority to produce a set of actions. Further, the execution of the executable code by the one or more units of the system causes the processor to capture a response of the respondent to a set of differentiation questions for a list of brands. Further, the execution of the executable code by the one or more units of the system causes the processor to compute a brand attribute matrix to determine one or more counts and corresponding percentages of the list of brands mentioned in the responses of the differentiation questions. Further, the execution of the executable code by the one or more units of the system causes the processor to calculate a differential matrix using statistical techniques, conduct significance testing on the differential matrix to compute a significance matrix and an equivalent points matrix for each brand and attribute combinations. Further, the execution of the executable code by the one or more units of the system causes the processor to normalize the counts to generate a percentile score for getting a brand edge score and a brand edge grade, further the grade so generated is used by a concerned authority to produce a set of actions. Further, the execution of the executable code by the one or more units of the system causes the processor to capture a response to a brand preference question. Further, the execution of the executable code by the one or more units of the system causes the processor to determine one or more counts and percentages of a list of brands mentioned in the response. Further, the execution of the executable code by the one or more units of the system causes the processor to normalize the counts to generate a percentile score for getting a brand preference score and a brand preference grade, further the grade so generated is used by a concerned authority to produce a set of actions. Further, the execution of the executable code by the one or more units of the system causes the processor to provide an actionable brand equity grade by combining the brand presence score, brand experience score, brand edge score and a brand preference score.

The present invention further provides a user equipment for determining actionable brand equity. The user equipment comprises a memory, a processor connected with the memory. The processor is configured to determine an actionable brand equity via a system. Further, the actionable brand equity is determined by determining if an individual brand pillar or all the brand pillars are to be assessed. The actionable brand equity is further determined by capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions. The actionable brand equity is further determined by capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions. The actionable brand equity is further determined by defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions. The actionable brand equity is further determined by capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions. The actionable brand equity is further determined by calculating an actionable brand equity grade as a composite grade by combining the brand presence score, brand experience score, brand edge score and a brand preference score.

Therefore, the present invention provides a system for determining actionable brand equity that utilizes four factors or parameters including brand presence, brand experience, brand edge and brand preference for evaluating and scoring brands under each parameter such that the final score or grade is actionable, and stakeholders may evaluate and determine the set of actions to be taken to improve the grade or score of a brand along a particular brand parameter or across all brand parameters. The present invention is extensible so that more brand parameters may be added to the framework later for evaluating other brand aspects.

The present invention may be a system, a method, and/or a computer program product at any possible technical detail level of integration. The computer program product may include a computer-readable storage medium (or media) having the computer-readable program instructions thereon for causing the one or more hardware processor to carry out aspects of the present invention.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include script, batch, or other executable files. The modules may be stored on a machine-readable or computer readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removable or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a module for calling sub-modules may be decomposed so that each sub-module performs its function and passes control directly to another sub-module.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A system (100) for determining actionable brand equity, comprising:
one or more processing units (101);
a memory (125) coupled to the one or more processing units (101) and the memory (125) include a plurality of modules (126) in the form of one or more instructions executable by the one or more processing units (101);
wherein:
the plurality of modules (126) include a data acquisition module (127) and a data processing module (128), a storage (130) that stores data sources (134) and survey responses (136);
the data processing module (128) is integrated with a brand presence assessment module (1281), a brand experience assessment module (1282), a brand edge assessment module (1283), and a brand preference assessment module (1284);
the brand presence assessment module (1281) is configured to:
capture a response of a top-of-mind awareness questionnaire from a respondent,
determine one or more counts and one or more percentages of a list of brands mentioned in the top-of-mind awareness questionnaire,
normalize the counts to generate a percentile score for getting a brand presence score and a brand presence grade and wherein the brand presence grade for a particular brand is used by a concerned authority to produce a set of actions;
the brand experience assessment module (1282) is configured to:
capture a response to the experience of the respondent with a list of currently used or recently used brands via utilizing a net promoter score technique,
convert the respondent ratings into corresponding ranks for each brand to determine the top ranking brands in the list, determine one or more counts and percentages of the list of brands mentioned in the response,
normalize the counts to generate a percentile score for getting a brand experience score and brand experience grade, further the grade so generated is used by a concerned authority to produce a set of actions;
the brand edge assessment module (1283) is configured to:
capture a response of the respondent to a set of differentiation questions for a list of brands,
compute a brand attribute matrix to determine one or more counts and corresponding percentages of the list of brands mentioned in the responses of the differentiation questions,
calculate a differential matrix using statistical techniques, conduct significance testing on the differential matrix to compute a significance matrix and an equivalent points matrix for each brand and attribute combinations,
normalize the counts to generate a percentile score for getting a brand edge score and a brand edge grade, further the grade so generated is used by a concerned authority to produce a set of actions;
the brand preference assessment module (1284) is configured to
capture a response to a brand preference question,
determine one or more counts and percentages of a list of brands mentioned in the response,
normalize the counts to generate a percentile score for getting a brand preference score and a brand preference grade, further the grade so generated is used by a concerned authority to produce a set of actions;
the plurality of modules also include a composite grading module for providing an actionable brand equity grade by combining the brand presence score, brand experience score, brand edge score and a brand preference score.

2. The system (100) for determining actionable brand equity as claimed in claim 1, wherein the data acquisition module (127) includes scanner, camera, keyboard, microphone, mouse and touchpad.

3. The system (100) for determining actionable brand equity as claimed in claim 1, wherein the data processing module (128) refers to a central processing unit and is preferably a microprocessor.

4. The system (100) for determining actionable brand equity as claimed in claim 1, wherein the data acquisition module (127) transfers the response from the respondent to the data processing module (128).

5. The system (100) for determining actionable brand equity as claimed in claim 1, wherein the system (100) further comprise of an input means (112) for receiving an input data and a data storage unit (130) for storing incoming input data or having a pre-stored data.

6. The system (100) for determining actionable brand equity as claimed in claim 1, wherein the set of actions refer to corrective measures, new initiatives, or any other suitable tasks.

7. The system (100) for determining actionable brand equity as claimed in claim 1, wherein the set of differentiation questions via the brand edge assessment module inquire about a plurality of attributes of brands, including quality, pricing, features, and customer service, to assess their unique selling propositions.

8. The system (100) for determining actionable brand equity as claimed in claim 1, wherein the actionable brand equity grade provided by the composite grading module is represented on a scale ranging from low to high, with an optional set of corresponding recommendations for improving brand equity.

9. The system (100) for determining actionable brand equity as claimed in claim 1, wherein the composite grading module provides the actionable brand equity grade which is presented on an output module.

10. The system (100) for determining actionable brand equity as claimed in claim 9, wherein the output module includes a graphical user interface which presents the actionable brand equity grade in a visual dashboard format and a downloadable report format for a clear visualization.

11. A method for determining actionable brand equity, comprising the steps of:
a) determining if an individual brand pillar or all the brand pillars are to be assessed;
b) capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions;
c) capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions;
d) defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions;
e) capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions;
f) calculating an actionable brand equity grade as a composite grade by combining the brand presence score, brand experience score, brand edge score and a brand preference score.

12. The method for determining actionable brand equity as claimed in claim 11, wherein the actionable brand equity framework includes but not limited to the brand pillars of brand presence, brand experience, brand edge and brand preference.

13. The method for determining actionable brand equity as claimed in claim 11, wherein the survey questionnaires comprise of a set of questions for the respondent.

14. The method for determining actionable brand equity as claimed in claim 11, wherein the normalized score or score range can be converted to an equivalent grade based on a score grading matrix.

15. The method for determining actionable brand equity as claimed in claim 11, wherein the set of actions refer to corrective measures, new initiatives, or any other suitable tasks.

16. The method for determining actionable brand equity as claimed in claim 11, wherein the set of differentiation questions via the brand edge assessment module inquire about a plurality of attributes of brands, including quality, pricing, features, and customer service, to assess their unique selling propositions.

17. The method for determining actionable brand equity as claimed in claim 11, wherein the actionable brand equity grade provided by the composite grading module is represented on a scale ranging from low to high, with an optional set of corresponding recommendations for improving brand equity.

18. The method for determining actionable brand equity as claimed in claim 11, wherein the actionable brand equity grade are displayed through a graphical user interface which presents the actionable brand equity grade and the related set of actions and recommendations for improving brand equity in a visual dashboard format and a downloadable report format for a clear visualization and interpretation.

19. A non-transitory computer-readable storage medium for storing one or more instructions for determining actionable brand equity, wherein the storage medium comprising an executable code which when executed by one or more units of a system causes a processor to:
a) capture a response of a top-of-mind awareness questionnaire from a respondent;
b) determine one or more counts and one or more percentages of a list of brands mentioned in the top-of-mind awareness questionnaire;
c) normalize the counts to generate a percentile score for getting a brand presence score and a brand presence grade and wherein the brand presence grade for a particular brand is used by a concerned authority to produce a set of actions;
d) capture a response to the experience of the respondent with a list of currently used or recently used brands via utilizing a net promoter score technique;
e) convert the respondent ratings into corresponding ranks for each brand to determine the top ranking brands in the list, determine one or more counts and percentages of the list of brands mentioned in the response;
f) normalize the counts to generate a percentile score for getting a brand experience score and brand experience grade, further the grade so generated is used by a concerned authority to produce a set of actions;
g) capture a response of the respondent to a set of differentiation questions for a list of brands;
h) compute a brand attribute matrix to determine one or more counts and corresponding percentages of the list of brands mentioned in the responses of the differentiation questions;
i) calculate a differential matrix using statistical techniques, conduct significance testing on the differential matrix to compute a significance matrix and an equivalent points matrix for each brand and attribute combinations;
j) normalize the counts to generate a percentile score for getting a brand edge score and a brand edge grade, further the grade so generated is used by a concerned authority to produce a set of actions;
k) capture a response to a brand preference question;
l) determine one or more counts and percentages of a list of brands mentioned in the response;
m) normalize the counts to generate a percentile score for getting a brand preference score and a brand preference grade, further the grade so generated is used by a concerned authority to produce a set of actions; and
n) provide an actionable brand equity grade by combining the brand presence score, brand experience score, brand edge score and a brand preference score.

20. A user equipment for determining actionable brand equity, comprising:
a memory;
a processor connected with the memory, wherein the processor is configured to determine an actionable brand equity via a system and the actionable brand equity is determined by:
a) determining if an individual brand pillar or all the brand pillars are to be assessed;
b) capturing a response of a top-of-mind awareness questionnaire for a brand presence assessment from a respondent, determining one or more counts and percentages of a list of brands mentioned in the top-of-mind awareness questionnaire, normalizing the counts to generate a percentile score for getting a brand presence score and brand presence grade and further the grade for a particular brand is used by a concerned authority to produce a set of actions;
c) capturing a response to the experience of the respondent with a list of currently used or recently used brands via utilizing a net promoter score technique for a brand experience assessment, converting the respondent ratings into ranks for each brand to determine the top ranking brands in the list, determining one or more counts and percentages of the list of brands mentioned in the response, normalizing the counts to generate a percentile score for getting a brand experience score and brand experience grade, further the grade so generated is used by a concerned authority to produce a set of actions;
d) defining a set of attributes to be evaluated for a brand, determining a list of competing brands for a brand edge assessment, capturing a response of the respondent to a set of differentiation questions for a list of brands, computing a brand attribute matrix to determine one or more counts and percentages of the list of brands mentioned in the responses of the differentiation questions, calculating a differential matrix using statistical techniques, conducting significance testing on the differential matrix to compute a significance matrix and an equivalent points matrix for each brand and attribute combinations, normalizing the counts to generate a percentile score for getting a brand edge score and a brand edge grade, further the grade so generated is used by a concerned authority to produce a set of actions;
e) capturing a response to a brand preference question, determining one or more counts and percentages of a list of brands mentioned in the response for a brand preference assessment, normalizing the counts to generate a percentile score for getting a brand preference score and a brand preference grade, further the grade so generated is used by a concerned authority to produce a set of actions; and
f) calculating an actionable brand equity grade as a composite grade by combining the brand presence score, brand experience score, brand edge score and a brand preference score.
